(19) United States
(12) Patent Application Publication
(10) Pub. No.: US 2004/0104785 A1
(43) Pub. Date: Jun. 3, 2004

(54) Variable impedance matching circuit

(76) Inventors: Pil Jae Park, Daejon-Shi (KR); Cheon Soo Kim, Daejon-Shi (KR); Mun Yang Park, Daejon-Shi (KR)

Correspondence Address: JACOBSON HOLMAN PLLC, 400 SEVENTH STREET N.W., SUITE 600, WASHINGTON, DC, 20004, US

(21) Appl. No.: 10/671,524

(22) Filed: Sep. 29, 2003

(30) Foreign Application Priority Data
Dec. 2, 2002 (KR) 2002-75751

(51) Int. Cl. H01P 5/02

(52) U.S. Cl. 333/33

(57) ABSTRACT

The present invention is directed to a circuit capable of matching variable impedances, and implements the variable impedance matching circuit by varying an electrical length of a transmission line by means of external control signals. In the L or π type matching circuit using inductance and capacitance as lumped elements, the variable impedance matching circuit is implemented by changing impedance values of the variable inductance and variable capacitance as lumped elements which have been made to be controlled, or by changing a topology of a circuit network by external control signals. Therefore, the variable impedance matching circuit according to the present invention enables it possible to electrically control an impedance of interest from arbitrary impedances, thereby a radio frequency circuit to which the variable impedance matching circuit belongs can be controlled, and the matching circuit can be implemented with arbitrary complex loads from any RF signal sources.

### BACKGROUND OF THE INVENTION

### FIELD OF THE INVENTION

The present invention relates to an impedance matching circuit of a radio frequency circuit, in particular, to a variable impedance matching circuit capable of variably matching RF impedances in accordance with control signals.

### DESCRIPTION OF THE PRIOR ART

In a radio frequency circuit, the matching circuit acts to transmit signals from one unit block to other one without an echo back (reflection of incident signal.) The conventional methods for implementing such a matching circuit have been disclosed. One of them is a method of using micro-strip lines and stubs, another is a method of implementing the matching π or L type circuit using lumped elements: capacitances, inductances.

The former has used micro-strip lines and stubs at fixed electrical lengths, and the latter has been implemented the matching circuit with fixed topology using inductance and capacitance; the matching circuit could not be changed once it has been implemented.

Thereafter, the impedance matching circuit implemented using the stubs will be explained with reference to FIG. 1. In this prior art, in order to match required impedances, a matching circuit network is used which comprises a transmission line having characteristic impedances and a stub parallely or serially connected thereto.

FIG. 1 shows the matching circuit network using stubs connected in parallel with each other. Referring to FIG. 1, a required real part of the impedance is obtained by varying the length 11 of the transmission line L11 having a characteristic impedance, and a required reactance value is obtained by adjusting the length 12 of the stub L12 connected in parallel to the transmission line L11. In this case, a matching circuit is designed by varying the length L11 of the transmission line L11 having the characteristic impedance and the length 12 of the stub as design parameters of a required matching circuit network. Such matching method using the stub is commonly used in the microwave frequency range.

Meanwhile, the matching circuit network can be implemented by using lumped-element inductance and capacitance. This matching circuit network can be implemented by using a π or L type circuit network in order to match the required impedance value. Two lumped elements are used for the L type circuit network as a design parameter, and a topology is determined by which side of the two lumped elements is grounded. And values of the two lumped elements are used for the design parameter. Also, three lumped elements are used for the π type circuit network, and a topology is determined by that which side of the three elements is grounded, and values of the three lumped elements are used for the design parameter.

Therefore, the matching methods using the stub and the lumped elements of the prior art can not vary the matching circuit after the matching circuit has been implemented as a hybrid or an integrated circuit.

### SUMMARY OF THE INVENTION

Therefore, one object of the present invention is to provide a variable impedance matching circuit capable of matching impedances by varying the electrical lengths of the transmission lines, with control signal operations of switches.

The other object of the present invention is to provide a variable impedance matching circuit capable of matching impedances by changing a topology of matching circuit or by changing values of the variable inductance or variable capacitance, with operations of the switch used in accordance with control signals.

To achieve the above objects, the variable impedance matching circuit in accordance with the present invention comprises at least one stub lines connected in parallel or serial to a transmission line. It is characterized in that the at least one stub lines and transmission line comprises at least one variable transmission line block which changes its electrical length using at least one of external signal(s) controlled switches.

To achieve the above objects, in a π type variable impedance matching circuit in accordance with the present invention, a first, a second, and a third lumped element connected with a shape of π type and at least one of switches, which are capable of being operated by external control signals, are connected to connection point(s) of lumped elements, wherein a topology is changed by selecting input/output ports or grounds using at least one of switches.

To achieve the above objects, in a L type variable impedance matching circuit using lumped elements in accordance with the present invention, first and second lumped elements are connected with a shape of L type and at least one of switches, which are capable of being operated by external control signals, are connected to connection point(s) of said lumped elements, wherein a topology is changed by selecting input/output ports or grounds using said at least one of switches.

The present invention relates to a variable impedance matching circuit capable of performing impedance match. The variable impedance matching circuit in accordance with the present invention has given impedance corresponding to a control signal by the external control signal in a radio frequency range. In other words, in the matching circuit using stubs, the variable impedance matching circuit is implemented by varying the electrical length of the conventional transmission line by means of the external control signal. And in the L or π type matching circuit using inductances and capacitances as lumped elements, the variable impedance matching circuit is implemented by changing the topology of the circuit network by means of the external control signals, or by having variable inductances or variable capacitances capable of being controlled as lumped elements thereby changing impedances thereof. When it comes to implement the variable impedance matching circuit using lumped elements, a topology of the matching circuit first needs to be selected by switches. As each component of the topology consists of the variable inductance or variable capacitance, a required impedance matching circuit can be implemented by changing values of the variable inductance and variable capacitance. Therefore, it is possible to control impedances from any ones to the ones to be matched by using the variable impedance matching circuit in accordance with the present invention. In addition, a radio frequency circuit to which the variable impedance matching circuit belongs can be controlled, thereby a matching circuit can be implemented from an arbitrary RF signal source to an arbitrary complex load.

Hereinafter, embodiments of the present invention will be explained with reference to the accompanying drawings. Although the present invention has been described in conjunction with the preferred embodiment, the present invention is not limited to the embodiments, and it will be apparent to those skilled in the art that the present invention can be modified in variation within the scope of the invention.

### BRIEF DESCRIPTION OF THE DRAWINGS

FIG. 1 shows a matching circuit network using parallel connected stubs.

FIG. 2 shows transmission lines capable of varying electrical lengths.

FIG. 3 shows a variable impedance matching circuit using stubs by connecting the variable transmission lines shown in FIG. 2.

FIG. 4 shows a variable impedance matching circuit using two stubs by connecting the variable transmission lines in parallel shown in FIG. 2.

FIG. 5 shows a π type variable impedance matching circuit.

FIG. 6 shows a L type variable impedance matching circuit.

FIG. 7 shows one embodiment in which the variable impedance matching circuit according to the present invention is applied to a radio frequency circuit.

FIG. 8 shows another embodiment in which the variable impedance matching circuit according to the present invention is applied to another radio frequency circuit.

### DESCRIPTION OF THE PREPERRED EMBODIMENTS

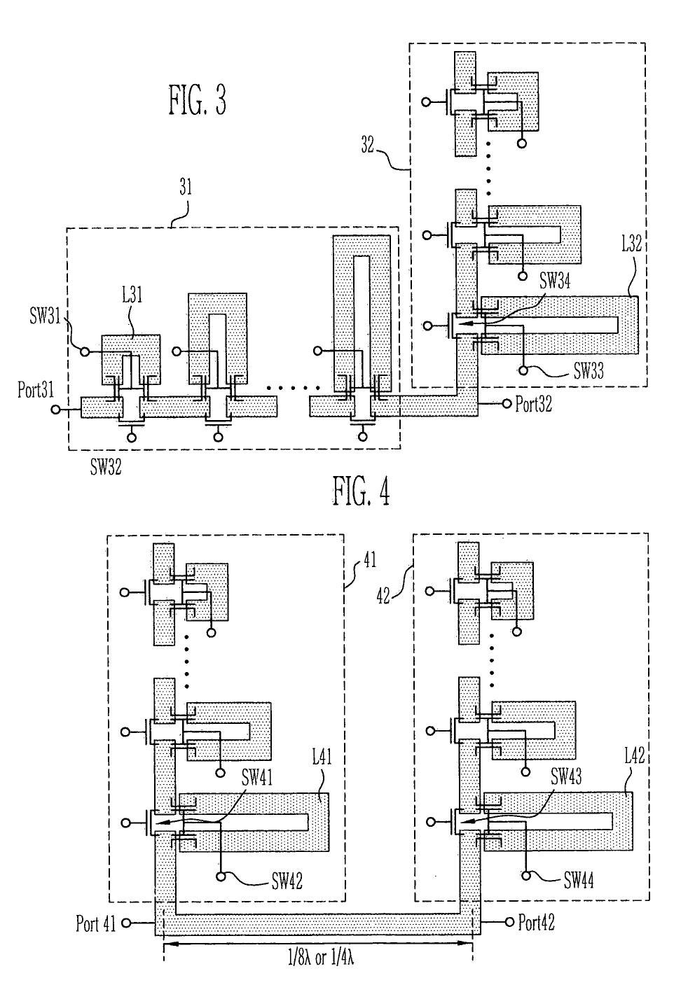

FIG. 2 shows transmission lines capable of varying electrical lengths. Referring to FIG. 2, the transmission lines can vary electrical lengths by changing the electrical paths of radio frequency signals by means of switches. Typically, a micro-strip line, which is a transmission line, formed on a substrate can have a predetermined thickness as shown in FIG. 2, and the electrical characteristic thereof can be changed in accordance with the width. The circuit as shown in FIG. 2 acts as a phase shifter in view of a fixed frequency. The transmission lines, capable of varying electrical lengths shown in FIG. 2, comprise 1 to N variable transmission line blocks. A first variable transmission line block B21 comprises switches SW21, SW22, and a transmission line L21. The switches SW21 and SW22 can be implemented as MOS transistors or PIN diodes which can function as switch, and the transmission line L21 has an electrical length θ 21. Other variable transmission line blocks B22, B23, . . . , B2N, having same structures as that of the first variable transmission line block B21, are consecutively connected, thereby a total variable transmission line are obtained. The nth transmission line L2N of the variable transmission line blocks has an electrical length θ 2N. Variable range of the θ 2N needs to have the value that the difference between the maximum and the minimum lengths is not less than ½λ. Therefore, the sum (Σ B2N) of variable length blocks is not less than ½λ. For example, method in which unit block (L=½λ)/N (wherein the N is a number of unit block) length is the same, has the transmission line length (N* Θ wherein the Θ is the length of unit block) by connecting N of unit block each other by means of the switches of the unit block. As a alternative, the length of the transmission line can be a different each of unit block; for example, the transmission line can be implemented having N of unit block comprising the longest transmission line of ¼λ, and the shortest transmission line of 1/(2*(N+1))λ in length. Therefore, the transmission line can be varied so that the electrical length thereof has resolution of 1/(2*(N+1)) multiplied by ½λ.

The operation of the first variable transmission line block B21 will be explained hereinafter. The transmission line L21 having electrical length θ 21 can be selected by using switches 21 and 22. In other words, when the switch SW21 is turned on and switch SW22 is turned off, an input signal input from the Port 21 flows through the L21. Therefore, the input signal flows through the transmission line that has long electrical length. On the other side, when the switch SW21 is turned off and switch SW22 is turned on, the input signal directly flows without through the L21 so that the electrical length of the transmission line can be varied depending on the operation of the switches SW21 and SW22. The electrical length of the total variable transmission line consisting of 1 to N variable transmission line blocks can be varied by the combination of switches for each block for cases up to 2^{N}. In addition, the variable transmission line shown in FIG. 2 acts as a phase shifter, so that the phase displacement can be changed to θ21, θ22, . . . , θ N by selecting the switches.

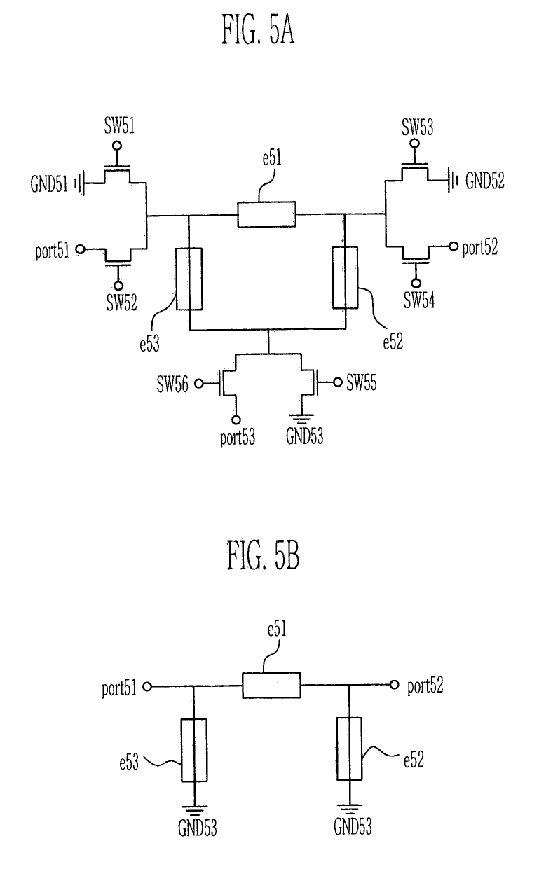

Hereinafter, the variable impedance matching circuit implemented using the variable transmission line shown in FIG. 2 will be explained with reference to FIGS. 3 and 4.

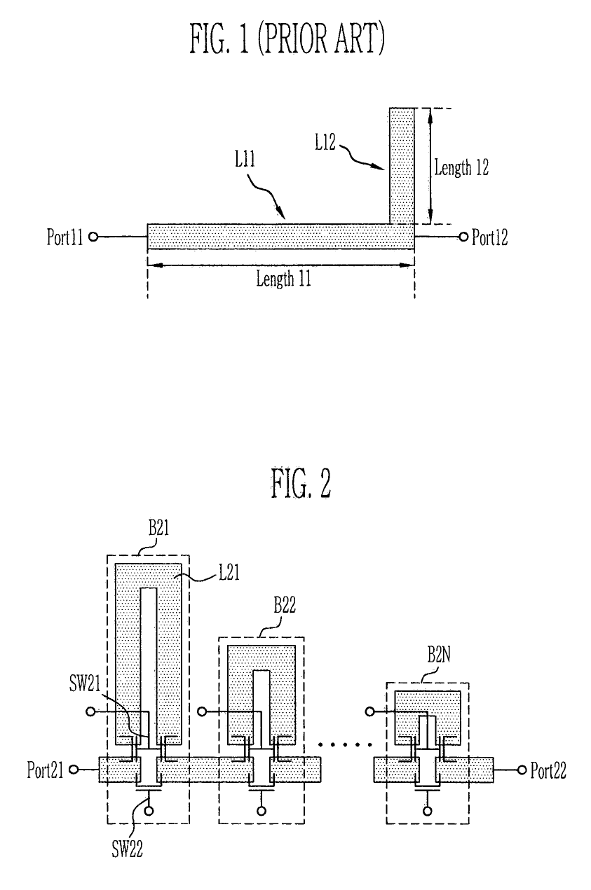

FIG. 3 shows the variable impedance matching circuit using stubs by connecting the variable transmission lines shown in FIG. 2. As explained above with reference to FIG. 1, the matching circuit using stubs consists of a transmission line part 31 and a stub line part 32 connected in parallel or serial to the transmission line. The variable impedance matching circuit can be implemented as shown in FIG. 3. Referring to FIG. 3, the variable impedance matching circuit consists of a transmission line part 31 and a variable length stub line part 32. First variable transmission line block of the transmission line L31 consists of a switch SW31, switch SW32, and a transmission line L31. Other blocks of the transmission line also consist of switches and a transmission respectively, so that the electrical length of the total transmission lines is varied. And the first transmission line variable block of the variable length stub line L32 also consists of a switch SW33, a switch SW34, and a transmission line L32, so that the electrical length of the total stub lines are varied by the operation of each transmission line variable lock. Signals are input from Port 31 and output to Port 32.

FIG. 4 shows a variable impedance matching circuit connecting two stubs in parallel to the variable transmission lines, respectively, as shown in FIG. 2. Referring to FIG. 4, the variable impedance matching circuit using two stubs in FIG. 4 consists of a first variable length stub line part 41, a second variable length stub line 42, and a transmission line to which the first variable length stub line part 41 and the second variable length stub line part 42 are connected at both ends thereof. The transmission line has an input Port 41 and an output Port 42. The first variable length stub line part 41 consists of plurality of variable transmission line blocks, and the first block thereof consists of a switch SW41, a switch SW42, and a transmission line L41. In addition, the second variable length stub line part 42 consists of plurality of variable transmission line blocks, and the first block thereof consists of a switch SW43, a switch SW44, and a transmission line L42. The electrical length of each variable transmission line block is varied depending on the operation of switches. In the case of typical double stub matching as shown in FIG. 4, the length of the transmission line is fixed (to ⅛λ or ¼λ), thereby the matching circuit can be implemented by varying the lengths of the two stubs in accordance with the required impedance.

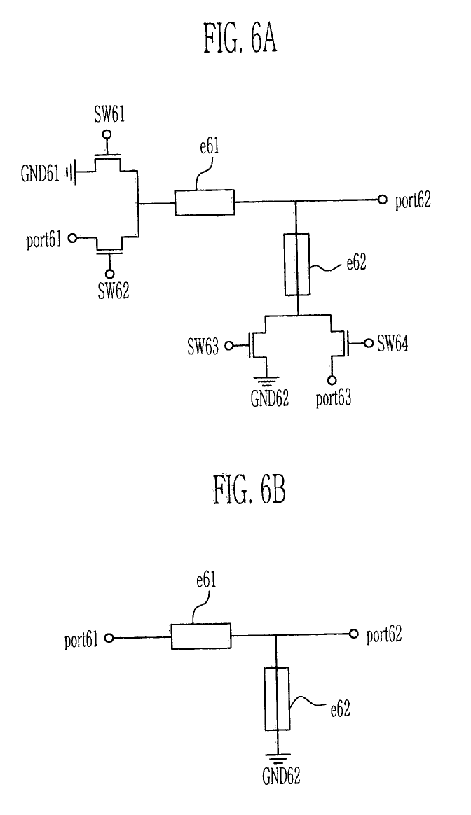

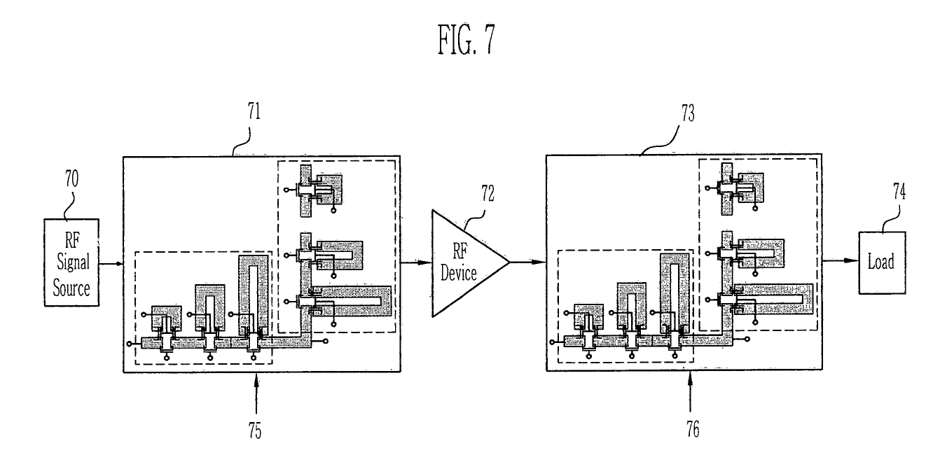

Hereinafter, π or L type variable impedance matching circuit using inductance and capacitance as lumped elements will be explained with reference to FIGS. 5A, 5B, 6A and 6B.

FIGS. 5A and 5B show π type variable impedance matching circuits. Referring to FIG. 5A, the variable capacitance and inductance are connected with a π shape. For example, the numerical references e51, e52, and e53 each can correspond to the variable capacitances or the variable inductances. Switches SW51 and SW52 are connected to the left side of e51, and the switch SW51 is connected to ground level GND51, and the switch SW52 to Port51. In addition, Switches SW53 and SW54 are connected to the right side of e51, and the switch SW53 is connected to ground level GND52, and the switch SW54 to Port 52. One ends of e52 and e53 are connected to e51, and the other ends thereof are connected to Switches SW55 and SW56, respectively.

FIG. 5B shows the π type impedance matching circuit implemented by the principle referring to FIG. 5A, and will be explained in accordance with the operation of FIG. 5A. When switch SW51 is turned on and switch SW52 off in FIG. 5A, then Port 51 is activated. When switch SW53 is turned off and switch SW54 on, the Port 52 is activated. And when the switch SW56 and turned off and switch SW55 on, the structure can be obtained in FIG. 5B by having one terminal of e53 and e52 grounded. By means of the switch control explained above, the variable inductance or the variable capacitance e51 can be positioned between input Port 51 and out Port 52, and e52 and e53 can be connected to the both terminals of e51.

FIGS. 6A and 6B shows the L type variable impedance matching circuit. Referring to FIG. 6A, the variable capacitance and inductance are connected with a L shape. For example, the numerical references e61 and e62 each can correspond to the variable capacitances or the variable inductances. The terminals of e61 and e62 are connected each other, thereby connected to Port 62, and the other terminals are connected to switches. For example, the other terminal of e61 is connected to switches SW61 and SW62, and switch SW61 is connected to ground level GND61, and switch SW62 to Port 61. The other terminal of e62 is connected to switches SW63 and SW64, and the switch SW63 is connected to ground level GND62, and the switch SW64 to Port 63.

FIG. 6B shows the L type impedance matching circuit implemented by the principle referring to FIG. 6A, and will be explained in accordance with the operation of FIG. 6A. When the switch SW61 is turned off and the switch SW62 on in FIG. 6A, then Port 61 is activated. And when the switch SW64 is turned off and the switch SW63 on, the structure shown in FIG. 6B can be obtained by having one terminal of e62 grounded.

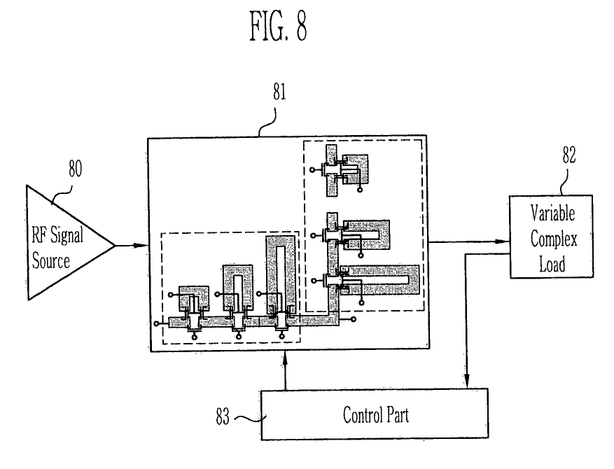

Hereinafter, the embodiment in which the variable impedance matching circuit according to the preferred embodiment of the present invention is applied to a radio frequency circuit will be explained with reference to FIGS. 7 and 8.

FIG. 7 shows one embodiment in which the variable impedance matching circuit according to the present invention is applied to a radio frequency circuit. The radio frequency circuit shown in FIG. 7 consists of a RF signal source 70, a first variable impedance matching circuit 71, a RF device 72, a second variable impedance matching circuit 73, and a load 74. First and second external control signals 75 and 76 are input to the first and second variable impedance matching circuits 71 and 72, respectively. The value of input impedance of the RF device 72 is different from that of output impedance of the RF signal source 70. Therefore, the impedances of the RF device 72 and RF signal source 70 need to be matched each other for the purpose of signal transmission without an echo back. And, the output of the RF device 72 should also be matched to the impedance of the load 74 to which the output be transmitted. At this time, as the input and output impedances of the RF device 72 are fixed, input and output of the RF device can be adjusted to arbitrary values by the variable impedance matching circuit in accordance with the present invention. For example, the first variable impedance matching circuit is connected between the RF signal source 70 and the RF device 71, and the second variable impedance matching circuit is connected between the RF device 72 and the load 74. Therefore, the RF device can be connected to the RF signal source as an input and to the load as an output, and then used.

FIG. 8 shows another embodiment in which the variable impedance matching circuit according to the present invention is applied to another radio frequency circuit. The radio frequency circuit shown in FIG. 8 consists of a RF signal source 80, a variable impedance matching circuit 81, a time variable complex load 82, and a control part 83. The radio frequency signal is transmitted from the RF signal source 80 to the time variable impedance matching circuit 81 by using the variable impedance matching circuit in accordance with the present invention. Referring to FIG. 8, the value of impedance of the time variable impedance matching circuit 81 is different from that of the RF signal source 80, and the value of impedance of the time variable complex load 82 varies as time proceeds. The output signal of the time variable complex load 82 is input to the control part 83, which in turn generates a control signal and input the control signal to the variable impedance matching circuit 81. Therefore, the variable impedance matching circuit 81 performs impedance matching between the RF signal source 80 and the variable complex load 82.

As explained above, the variable impedance matching circuit according to the present invention, varies the electrical lengths of transmission lines, changes the topology of the variable inductance or variable capacitance as lumped elements, or varies the values of the variable inductance or variable capacitance by using the operation of switches in accordance with the control signal, thereby adaptive impedance matching can be performed to an arbitrary RF circuit. In particular, when the load to which the RF signal is transmitted varies as time proceeds, matching can be performed in accordance with the variable load, and digital control is available, thereby the RF related signal or device could be digitally controlled.

Although the present invention has been described in conjunction with the preferred embodiment, the present invention is not limited to the embodiments, and it will be apparent to those skilled in the art that the present invention can be modified in variation within the scope of the invention.

What is claimed is:

1. A variable impedance matching circuit having at least one stub lines connected in parallel or serial to a transmission line, characterized in that,
said at least one stub lines and said transmission line comprises at least one variable transmission line block changing an electrical length of the transmission line using at least one of switches operated by external control signal(s).

2. The variable impedance matching circuit as claimed in claim 1, wherein said at least one of switches are a MOSFET or a Pin diode.

3. A π type variable impedance matching circuit comprising:
a first, a second, and a third lumped element connected with a shape of π type;
at least one of switches which are capable of being operated by external control signals, connected to connection point(s) of said lumped elements,
wherein a topology is changed by selecting input/output ports or grounds using said at least one of switches.

4. A π type variable impedance matching circuit as claimed in claim 3,
wherein said first, second, and third lumped elements are variable inductances or variable capacitances.

5. A L type variable impedance matching circuit using lumped elements, characterized in that
a first and second lumped elements connected with a shape of L type; and
at least one of switches which are capable of being operated by external control signals, connected to connection point(s) of said lumped elements,
wherein a topology is changed by selecting input/output ports or grounds using said at least one of switches.

6. A L type variable impedance matching circuit as claimed in claim 5,
wherein said first, and second lumped elements are variable inductances or variable capacitances.
